(19) United States
(12) Patent Application Publication
(10) Pub. No.: US 2024/0422860 A1
(43) Pub. Date: Dec. 19, 2024

(54) MOBILE DEVICE ACTIONABLE MESSAGING

(71) Applicant: Sennco Solutions, Inc., Plainfield, IL (US)

(72) Inventors: Brian Peacock, Melbourne, FL (US); Raymond Devito, Melbourne, FL (US); Stephen M. Strom, Olmsted, OH (US); Elmer Gordon Huebner, Aurora, IL (US)

(21) Appl. No.: 18/742,645

(22) Filed: Jun. 13, 2024

Related U.S. Application Data
(60) Provisional application No. 63/472,751, filed on Jun. 13, 2023.

(51) Int. Cl. H04W 76/30; H04W 76/10

(52) U.S. Cl. CPC H04W 76/30; H04W 76/10

(57) ABSTRACT

A method of enforcing a cellular connection policy for a mobile device includes receiving, by a processor of an enterprise mobility management (EMM) server computer, an instruction to enforce compliance with the cellular connection policy, the instruction being sent from a compliance server computer, and, in response to the received instruction, sending, by the processor, an EMM command to a device policy controller on the mobile device. The EMM command configures the device policy controller to control the mobile device to enforce compliance with the cellular connection policy.

### CROSS-REFERENCE TO RELATED APPLICATION

This application claims the benefit of U.S. provisional application entitled “Mobile Connection Control Trigger,” filed on Jun. 13, 2023, and assigned Ser. No. 63/472,751, the entire disclosure of which is hereby expressly incorporated by reference.

### BACKGROUND OF THE DISCLOSURE

### Field of the Disclosure

The disclosure relates to enforcement of mobile device connectivity service criteria.

### Brief Description of Related Technology

Internet and device providers offer programs in which provision of services and/or devices to their customers is predicated on compliance with predefined, connectivity-based criteria. Customers are required to satisfy the predefined criteria to remain qualified for the programs. The predefined criteria have included or involved connectivity-based parameters, such as activation date, timespan, data usage, and cellular connectivity. Ensuring and enforcing compliance with these connectivity-based parameters without manual steps or other intervention has been challenging.

### SUMMARY OF THE DISCLOSURE

In accordance with one aspect of the disclosure, a method of enforcing a cellular connection policy for a mobile device includes receiving, by a processor of an enterprise mobility management (EMM) server computer, an instruction to enforce compliance with the cellular connection policy, the instruction being sent from a compliance server computer, and, in response to the received instruction, sending, by the processor, an EMM command to a device policy controller on the mobile device. The EMM command configures the device policy controller to control the mobile device to enforce compliance with the cellular connection policy.

In accordance with another aspect of the disclosure, a system for enforcing a cellular connection policy for a mobile device includes a memory on which an enterprise mobility management (EMM) command is stored, and a processor configured to send the EMM command to a device policy controller on the mobile device in response to an instruction from a compliance server computer to enforce compliance with the cellular connection policy. The EMM command configures the device policy controller to control the mobile device to enforce compliance with the cellular connection policy.

In connection with any one of the aforementioned aspects, the systems and/or methods described herein may alternatively or additionally include or involve any combination of one or more of the following aspects or features. The device policy controller is further configured by the EMM command to cause the mobile device to display, by a user interface of the mobile device, a message to toggle a noncompliance notification upon receipt of the EMM command from the EMM server computer. The device policy controller is further configured by the EMM command to cause the mobile device to deactivate a Wi-Fi connection of the mobile device upon receipt of the EMM command from the EMM server computer. The device policy controller is further configured by the EMM command to cause the mobile device to activate a cellular connection of the mobile device upon receipt of the EMM command from the EMM server computer. The device policy controller is further configured by the EMM command to cause the mobile device to verify a cellular connection of the mobile device upon receipt of the EMM command from the EMM server computer. The device policy controller is further configured by the EMM command to cause the mobile device to send cellular data through a cellular antenna of the mobile device to a cellular network. The device policy controller is further configured by the EMM command to cause the mobile device to send a compliance message to the compliance server computer based on whether the compliance with the cellular connection policy has been achieved. The device policy controller is further configured by the EMM command to cause the mobile device to re-activate a Wi-Fi connection of the mobile device based on whether the compliance with the cellular connection policy has been achieved. The device policy controller is configured to send data indicative of an amount of cellular data used by the mobile device to the compliance server computer. The instruction is sent from the compliance server computer based on whether a cellular data threshold has been satisfied by the mobile device, based on an activation date of the mobile device, based on a non-activation date of the mobile device, or based on a check-in date.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 depicts a system for enforcing a cellular connection policy for a mobile device in accordance with one example.

FIG. 2 depicts a flow diagram of a method for enforcing a cellular connection policy for a mobile device in connection with a cellular data connection in accordance with one example.

FIG. 3 depicts a flow diagram of a method for enforcing a cellular connection policy for a mobile device triggered via cellular hour usage data in accordance with one example.

FIG. 4 depicts a flow diagram of a method for enforcing a cellular connection policy for a mobile device triggered via cellular data unit usage in accordance with one example.

FIG. 5 depicts a flow diagram of a method of enforcing a cellular connection policy for a mobile device based on a trigger event in accordance with one example.

FIG. 6 depicts a flow diagram of a method of enforcing a cellular connection policy for a mobile device based on an activation date in accordance with one example.

FIG. 7 depicts a flow diagram of a method of enforcing a cellular connection policy for a mobile device based on a past activation date in accordance with one example.

FIG. 8 depicts a flow diagram of a method of enforcing a cellular connection policy for a mobile device based on a last check-in date in accordance with one example.

FIG. 9 depicts a flow diagram of a method of enforcing a cellular connection policy for a mobile device in accordance with one example.

FIG. 10 depicts a flow diagram of method of enforcing a cellular connection policy for a mobile device in accordance with one example.

The embodiments of the disclosed systems and methods may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

Systems and methods for enforcing a cellular connection policy (i.e., “compliance” with the policy) for a mobile device through actionable messaging are described. Aspects of the disclosed systems and methods are implemented by an enterprise mobility management server computer configured to direct a device policy controller on the mobile device. The enforcement is accordingly provided in a manner integrated with the mobile device.

Aspects of the disclosed systems and methods are implemented via communications from the enterprise mobility management server computer and/or other computers in communication with the mobile device. The communications may be or include supervised mode communications, e.g., enterprise mobility management (EMM) communications. The EMM or other supervision-related aspects of the disclosed methods and system may also be used to maintain the persistence of the compliance functionality on the device.

The disclosed systems and methods implement the compliance techniques to facilitate automatic checks for compliance with a mobile device's cellular connection. Upon receiving instructions from a supervised communication, the device initiates a compliance check to ensure adherence to specified programs or contract requirements.

The integrated nature and other aspects of the compliance techniques may enable internet providers to enforce agreements with mobile device users via compliance checks. Alternatively, these techniques may allow internet providers to provide evidence to the government, demonstrating the provision of services to low-income households.

The compliance check is provided in a persistent manner despite using elements installed on the device that are non-persistent. For example, the operation of an agent or app installed on the device to provide or otherwise support the security monitoring may be discontinued by, for instance, a power cycle or device reset. The compliance check is nonetheless provided by the disclosed methods and systems in a persistent manner via EMM or other supervision-related techniques to ensure that the elements are re-installed and operational.

The manner in which the compliance check is provided is useful in connection with electronic devices that do not allow access to boot instructions or other firmware. Lack of access to the device firmware presents a technical problem. The firmware cannot be reconfigured to ensure that compliance check instructions are persistently executed by the electronic device. Execution of the compliance check instructions on the electronic device may thus be discontinued by a user simply by, for instance, closing an application (e.g., app), rebooting the device, or power cycling the device.

The boot instructions may nonetheless be relied upon to support the persistence and provisioning of compliance check functionality on the device. In some cases, the boot instructions may enable the enrollment of the device in a supervision scheme or system. The execution of the boot instructions may thus provide an opportunity to confirm that the compliance check functionality is installed on the device. In this way, a factory or other hard reset of the device that removes elements of the compliance check functionality from the device may be thwarted.

The disclosed techniques provide enforcing a compliance check despite the possibility of discontinuation of a compliance check routine on the device—by relying on EMM-based or other supervision of the device. The supervision allows the device to send and receive supervised mode communications via a supervisory computer (e.g., a supervisory server computer) associated with implementing the supervision. In some cases, the supervised mode communications involve provisioning the device with an agent, app, or other instructions or data used to implement the compliance check functionality. The instructions may cause the application to control the mobile device to enforce the check.

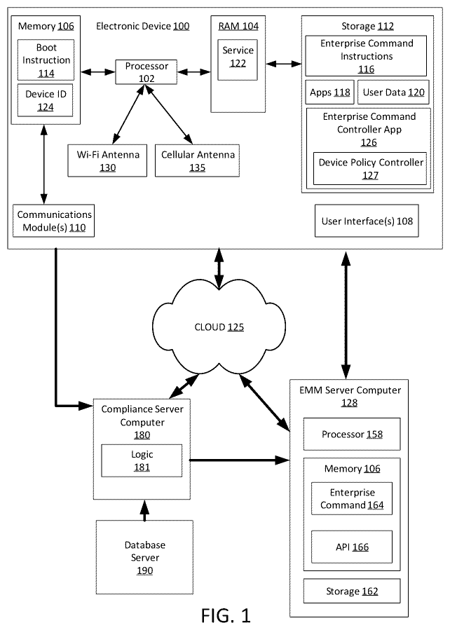

Turning to the drawing figures, FIG. 1 depicts a system for enforcing compliance of a mobile device 100 with a respect to a cellular connection. The mobile device 100 may be a smartphone, tablet, or laptop computer. The mobile device 100 may or may not be considered to be or include a computer or computing device. For instance, mobile device 100 may be a television or monitor. The size, form factor, and other characteristics of the mobile device 100 may thus vary considerably.

The mobile device 100 includes a processor 102. The processor 102 executes instructions to implement the methods of enforcing compliance of a mobile device as described herein. Indeed, the processor 102 may be the primary processor of the electronic device 100. For instance, the processor 102 may be used to perform any number of non-compliance-related processing tasks or operations for the mobile device 100. In some cases, the processor 102 is or includes a central processing unit (CPU) or other general-purpose processing unit. For example, the processor 102 may be a microprocessor, microcontroller, programmable logic array (PLA), or field programmable gate array (FPGA). Alternatively or additionally, the processor 102 is or includes dedicated or specific processing functionality. For instance, the processor 102 may be or include a graphics processing unit (GPU), a digital signal processor (DSP), or other type of application-specific processor or processing unit. In some cases, the processor 102 is implemented as an application-specific integrated circuit (ASIC). The processor 102 may include one or more processing cores or other units integrated with one another to any extent. The processor 102 may be provided on one or more integrated circuits or integrated circuit (IC) chips. The processor 102 may be integrated with one or more other components of the mobile device 100, such as a memory unit or a communications module. For example, in some cases, the processor 102 is a component of a system-on-a-chip (SoC).

As mentioned above, the processor 102 may be used to perform any number of non-compliance-related processing tasks or operations for the mobile device 100. For example, the processor 102 may be configured to enable and disable a Wi-Fi antenna 130 and a cellular antenna 135 of the mobile device 100. The processor 102 may also be configured to display a message, via a user interface 108, and transmit and receive instructions/commands from the compliance server 180, the EMM server 128, and the cloud 125 (i.e., cellular network, internet network, or the like).

The mobile device 100 includes one or more memory units on which instructions are stored. The instructions configure the processor 102 or other cause the processor 102 to implement tasks or other operations. In the example of FIG. 1, the mobile device includes a random access memory (RAM) or other volatile memory 104 and a persistent memory 106. Both of the memories 104, 106 may be directly addressable and accessible by the processor 102 via, for instance, a memory bus. The persistent memory 106 may be read-only memory (ROM) or other non-volatile memory. Firmware for the mobile device 100 may be stored on the persistent memory 106. Each of the RAM 104 and the persistent memory 106 may include one or more memory units or memories (e.g., memory chips).

In the example of FIG. 1, the electronic device 100 includes one or more user interfaces 108 and one or more communication modules 110. The user interface 108 establishes the manner in which a user interacts or otherwise uses the electronic device 100. For instance, the user interface 108 may include a display, such as a touchscreen or graphical user interface (GUI). Alternative or additional user interfaces may be provided, including, for instance, a keyboard, speaker, microphone, or other input/output device. The communication module 110 supports communications, such as wireless communications, with remote devices. In some cases, the communication module 110 may include an antenna, a transceiver, and/or other components for supporting the communications. The communications may be in accordance with various communication protocols.

The mobile device 100 also includes a storage device 112. Data stored on the storage device 112 is not directly addressable by the processor 102, in contrast to the memories 104, 106. In the example shown, data on the storage device 112 is copied to the RAM 104 prior to use by the processor 102. The storage device 112 may be or include flash storage in the form of a solid state drive (SSD). Alternatively or additionally, the storage device 112 is or includes a hard disk drive. The storage device 112 may include one or more storage devices. The configuration, construction, storage technology, and other characteristics of the storage device 112 may vary.

Boot instructions 114 are stored on the persistent memory 106. In some cases, the boot instructions 114 are stored as firmware of the mobile device 100. The firmware of the electronic device 100 may thus include the boot instructions 114 in some cases. The processor 102 is configured to execute the boot instructions 114 during a boot sequence of the electronic device 100. The boot sequence may be any startup sequence, including, for instance, a sequence implemented at a power cycle, power-on, factory or other reset, or other restart or startup. In some cases, the boot instructions 114 are implemented as a basic input/output system (BIOS) routine or a portion thereof. In other cases, the boot instructions 114 may be called by a BIOS routine as, for instance, a subroutine. The boot instructions 114 are not limited to instructions set forth in, or called by, a BIOS routine. For example, the boot instructions 114 may be implemented in connection with a loading of an operating system for the mobile device 100.

The mobile device 100 may be managed by a server computer or other remote device, e.g., of an enterprise. In the example of FIG. 1, the supervisory server computer is or includes an enterprise mobility management (EMM) server computer 128. The EMM server computer 128 is used to provision and otherwise maintain the compliance functionality of the device 100 and to support the automatic control of the device 100 in connection with trigger events, as described below. In some cases, the supervision is provided in accordance with a mobile device management (MDM) or enterprise mobility management (EMM) platform, protocol or standard. Other platforms, protocols or standards may be used. Any supervision services provided by such platforms, protocols, or standards are considered to be EMM services as the terms “enterprise mobility management” and “EMM” are used herein.

Instructions 116 (e.g., EMM instructions) and other data related to the supervised mode may be stored in the storage 112. Alternatively or additionally, such data may be stored as firmware in the memory 106, and/or elsewhere on the device 100. In some cases, the boot instructions 114 may include instructions directed to triggering the execution of the supervision-related instructions 116. For example, the processor 102 is configured to execute the boot instructions 114 during the boot sequence to initiate execution of the compliance-related instructions 116. In some cases, the boot instructions 114 may include one or more subroutine or other calls or other references to the supervision-related instructions 116. The supervision functionality is thus initiated upon any rest or restart of the electronic device 100.

The nature of the supervision-related instructions 116 may vary. For instance, the supervision-related instructions 116 may alternatively or additionally include or otherwise be directed to specifying configuration details for the device 100 and/or data indicative of the supervisory server computer or other remote device.

Initiation of the execution of the supervision-related instructions 116 at reset or startup is accomplished despite storage of the supervision-related instructions 116 outside of the persistent memory 106. The supervision-related instructions 116 may be stored in the storage device 112 alongside applications 118 and user data 120. The applications 118 may be or include applications (e.g., apps) installed on the electronic device 100. The user data 120 may be or include data generated as a result of execution of, or stored for use by, one of the applications 118 (e.g., configuration data).

The nature of the boot instructions 114 related to the supervision-related functionality may vary. For instance, the manner in which the boot instructions 114 initiates execution of the supervision-related instructions 116 may vary. In some cases, the supervision-related portions of the boot instructions 114 are configured as a callout or other reference to the supervision-related instructions 116. The callout or other reference may be set forth in the boot instructions 114 in the context of establishing a persistent or other background application or service 122 to be executed or implemented by the mobile device 100. As described below, the background service 122 may be or include an agent configured to support EMM or other supervised mode communications with the server computer 128. Instructions and/or other data associated with the background service 122 may be stored in the RAM 104 for use by the processor 102. The callout or other reference limits the amount of persistent memory consumed by the security-related boot instructions 114.

In other cases, the boot instructions 114 set forth instructions beyond a callout or reference to the supervision-related instructions 116. For instance, the boot instructions 114 may include instructions directed to determining whether the supervision instructions 116 should be called or otherwise initiated. To that end, for instance, the device ID 124 may be accessed from the persistent memory 106. Processing of the boot instructions 114 may cause the processor 102 to send a query with the device ID 124 to determine whether the electronic device 100 (e.g., this particular instance of the electronic device 100) should be subjected to supervision. In the example of FIG. 1, the query is sent via the internet (e.g., cloud) 125 to either the compliance server computer 180 and/or the supervisory server computer device 128 (e.g., EMM server computer) or other server computer. Network communications with the server computer 128 may be supported by an antenna 130 of the mobile device 100. The supervisory computer device 128 may be configured to provide or otherwise support the implementation of the supervision functionality (e.g., a compliance mode of operation) on the mobile device 100. Other networked and non-networked devices may be contacted or accessed to determine whether the supervision functionality should be implemented. The supervision functionality may be initiated in other ways, including, for instance, a flag or other configuration data setting in the memory 106.

The supervisory server computer 128 may be or include one or more networked computing devices in communication with the mobile device 100. The computing device(s) may be disposed in, or made available via, a private or public cloud computing infrastructure in communication with the internet 125. In the example shown, the supervisory server computer 128 includes a processor 158, a memory 160, and a storage device 162. Supervisor instructions 164 (e.g., enterprise command) are stored on the memory 160 for execution by the processor 158. The processor 158 of the supervisory server computer 128 is configured via execution of the supervisor instructions 164 to implement EMM or other supervision functionality, including the supervised mode communications. In the example of FIG. 1, the supervisor instructions 164 and/or other instructions define an application program interface (API) 166.

The API 166 is used by the compliance server computer 180 and other server computers to direct the supervisory server computer 128 to, in turn, direct the device 100 to enforce compliance. For example, the compliance server computer 180 may send an API call to the supervisory server computer 128. Using the API call, the enterprise command 164 may configure the processor 158 of the EMM server computer 128 to issue a compliance check for the mobile device 100.

The compliance server computer 128 includes a logic controller 181. The logic controller 181 may determine whether a user is compliant. For example, the logic controller 181 may determine whether to send a compliance command to the EMM server computer 128 to enforce a check of the compliance of the mobile device 100. The logic controller 181 may determine to send a compliance command based on a trigger event. The trigger event may be initiated by an operator, based on a date of a program, based on an activation date, based on a check-in date, based on a deactivation date, based on cellular data usage, based on a threshold of data usage, and the like.

Upon receiving, by a processor 158 of an enterprise mobility management (EMM) server computer 128, instructions to enforce a check of the compliance of the mobile device 100, from the compliance server computer 180, the EMM server computer 128 may send an enterprise command to the mobile device 100.

Upon receiving a compliance check command from the EMM server computer 128, the enterprise command instructions 116 may cause the enterprise command controller application 126 to control the mobile device 100. For instance, the enterprise command controller application 126 may include a device policy controller (DPC) 127 to enforce a compliance check based on the enterprise command instructions 116.

The device policy controller 127 serves as a central management tool for configuring, monitoring, and enforcing policies on mobile devices. The device policy controller 127 is configured to control the wi-fi antenna 130, the cellular antenna 135, email configurations, security policies, application permissions, and more of the mobile device 100. The DPC 127 helps deploy polices (e.g., compliance checks) to manage the device 100. The EMM server communicates with the DPC 127 installed on managed devices to deploy the configured policies. This deployment can be done over-the-air (OTA) or through physical connections, depending on the EMM or MDM solution being used. The DPC 127 also provides ongoing management capabilities to remotely monitor device compliance, track device locations, push updates, and enforce security measures.

As mentioned above, upon receiving a compliance check command from the EMM server computer 128, the enterprise command instructions 116 may cause the enterprise command controller application 126 to control the mobile device 100. The device policy controller 127 of the enterprise command controller application 126 controls the mobile device 100 to enforce a compliance check based on the enterprise command instructions 116. Compliance with respect to cellular data usage on the mobile device is necessary to upkeep the device, as mandated by the program. For example, the program may outline cellular data usage within a certain time frame such as minutes, days, weeks, and the like, for the mobile device user to comply with.

Additionally, a database server 190 may be in communication with the compliance server computer 180. The database server 190 may store data including personal information about each user, program policies, and the like. The data of the database server 190 may be transmitted to the compliance server computer 180 and used by the logic controller 181 to determine compliance and trigger events. Additionally, data received from the compliance server computer 180 may be stored in the database server 190.

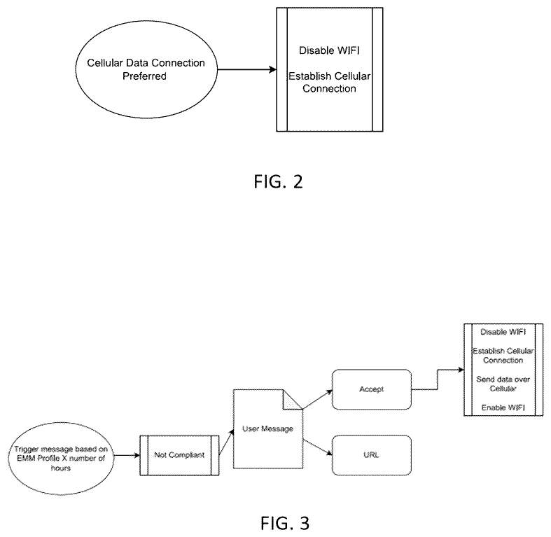

FIGS. 2-8 depict flow diagrams of different cases of enforcing a compliance of a mobile device with a respect to a cellular connection.

Referring to FIG. 2, upon detection of a trigger event, the server computer 180 may send instructions to enforce a check of the compliance of the mobile device 100 to the EMM server computer 128. The compliance check may be determined by the logic controller 181 of the server computer 180. The EMM server computer 128 may send an enterprise command to the mobile device 100. The enterprise command instructions 116 may cause the enterprise command controller application 126 to control the mobile device 100. The device policy controller 127 of the enterprise command controller application 126 may control the mobile device 100 to activate or establish a cellular connection by disabling a Wi-Fi connection of the mobile device 100 and enabling a cellular connection. The device policy controller 127 may then disable the wi-fi antenna 130 and enable the cellular connection 135.

Referring to FIG. 3, the logic controller 181 may transmit a compliance command based on whether a certain number of hours have passed since the user received or acknowledged the program/contract.

Based on the enterprise command 164, the enterprise command instructions 116 may cause the device policy controller 127 of the enterprise command controller application 126 to control the mobile device 100. The device policy controller 127 of the enterprise command controller application 126 may control the mobile device 100 after a certain number of hours (e.g., designated timeframe) have passed or a period of time the user had the mobile device 100, to enforce compliance with cellar data usage to maintain the mobile device 100, as agreed upon in the program/contract.

Upon reaching the designated duration, the compliance server computer 180 may send instructions to enforce a check of the compliance of the mobile device 100 to the EMM server computer 128. The EMM server computer 128 may send an enterprise command 164 to the mobile device 100. The device policy controller 127 of the enterprise command controller application 126 may then initiate a compliance check to assess user adherence based on various factors, such as data usage. In instances of non-compliance, the device policy controller 127 may notify the user through messages or notifications delivered via the mobile device 100. These notifications can be displayed on the user interface 108 of the mobile device 100 or audibly presented. The message may prompt the user to acknowledge their compliance status within the program and could include a URL redirecting the user to a website offering comprehensive details regarding the program requirements and compliance protocols. Upon the user accepting the non-compliance message, the device policy controller 127 may initiate the compliance check.

For example, the device policy controller 127 may disable the wi-fi antenna 130 and enable the cellular connection via the cellular antenna 135. The device policy controller 127 may then control the mobile device 100 to transmit data via the cellular connection to the cellular network 125. Upon transmitting data via the cellular connection, the device policy controller 127 may control the mobile device 100 to re-establish the wi-fi connection. As a result, the device policy controller 127, based on the enterprise command instructions 116, ensures that some data is able to transfer over the cellular connection onto the cellular network 125. The data may then be provided to the logic controller 181 of the compliance server computer 180 to determine compliance.

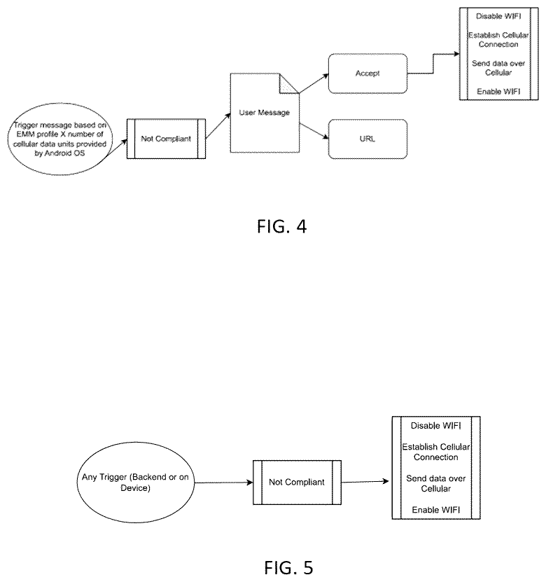

Referring to FIG. 4, the logic controller 181 may determine to transmit a compliance command based on an amount of data usage or a threshold of data usage.

Based on the enterprise command 164, the enterprise command instructions 116 may cause the device policy controller 127 of the enterprise command controller application 126 to control the mobile device 100 based on the amount of data usage.

For example, the device policy controller 127 may enforce a compliance check based on an amount of cellular data usage. The device policy controller 127 may control the mobile device to display a non-compliant message on the device 100. The message may prompt the user to acknowledge their compliance status within the program and/or could include a URL redirecting the user to a website offering comprehensive details regarding the program requirements and compliance protocols. Upon accepting/acknowledging the compliance message, the device policy controller 127 may disable the wi-fi antenna 130 and enable the cellular connection via the cellular antenna 135. The device policy controller 127 may then control the mobile device 100 to transmit data via the cellular connection to the cellular network 125. Upon transmitting data via the cellular connection, the device policy controller 127 may control the mobile device 100 to re-establish the wi-fi connection. The amount of data usage may then be provided to the logic controller 181 of the compliance server computer 180 to determine compliance.

Referring to FIG. 5, the logic controller 181 may determine transmit a compliance command based on any trigger event. For example, the compliance server computer 180 may send a compliance command to the EMM server 128, which transmits an enterprise command 164 to the mobile device 100. As mentioned above, upon receiving a compliance check command from the EMM server computer 128, the enterprise command instructions 116 may cause the device policy controller 127 of the enterprise command controller application 126 to control the mobile device 100. The trigger event may be based on a certain timeline, usage data, or other factors. Such factors may include location-based conditions, network connectivity status changes, battery level thresholds, application usage patterns, security-related events, device hardware changes or malfunctions, user activity patterns, policy updates from the enterprise, integration with other systems, and compliance with regulatory requirements.

As mentioned above, based on the compliance command instructions 116, the device policy controller 127 may control the mobile device 100 to display a non-compliant message on the device 100. The message may prompt the user to acknowledge their compliance status within the program. Upon accepting/acknowledging the compliance message, the device policy controller 127 may disable the wi-fi antenna 130 and enable the cellular connection via the cellular antenna 135. The device policy controller 127 may then control the mobile device 100 to transmit data via the cellular connection to the cellular network 125. Upon transmitting data via the cellular connection, the device policy controller 127 may control the mobile device 100 to establish the wi-fi connection. The data may then be provided to the logic controller 181 of the compliance server computer 180 to determine compliance.

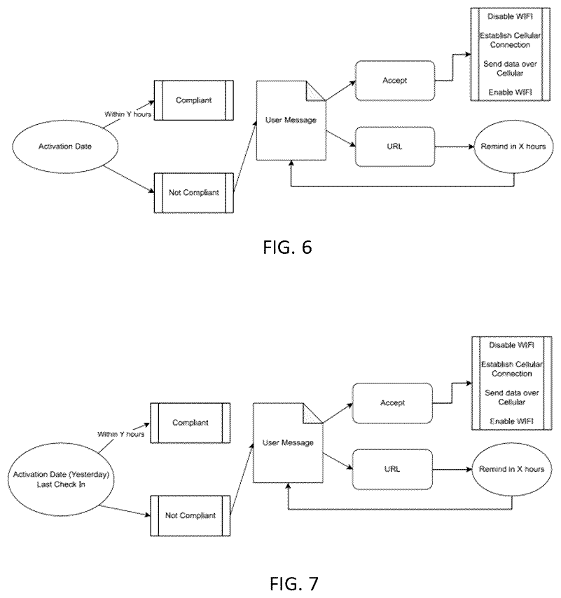

Referring to FIG. 6, the logic controller 181 may determine to transmit a compliance command based on an activation date.

For example, based on an activation date, the compliance server computer 180 may transmit a compliance command to the EMM server 128. Upon receiving an enterprise command 164 from the EMM server computer 128, the enterprise command instructions 116 may cause the enterprise command controller application 126 to control the mobile device 100. The device policy controller 127 of the enterprise command controller application 126 may control the mobile device 100 to display a non-compliant message on the device 100. The message may prompt the user to acknowledge their compliance status within the program. Upon accepting/acknowledging the compliance message, the device policy controller 127 may disable the wi-fi antenna 130 and enable the cellular connection via the cellular antenna 135. The device policy controller 127 may then control the mobile device 100 to transmit data via the cellular connection to the cellular network 125. Upon transmitting data via the cellular connection, the device policy controller 127 may control the mobile device 100 to re-establish the wi-fi connection. The message may also provide a URL. The URL may redirect the user to a website offering comprehensive details regarding the program requirements and compliance protocols. Furthermore, the URL may send a reminder within a certain time for the user to acknowledge and accept the compliance check if the user has not done so previously. The data pertaining to the compliance check may then be provided to the logic controller 181 of the compliance server computer 180 to determine compliance.

For instance, after program activation, if a certain number of days elapses (e.g., 14 days) without the user completing the required complaint steps, a compliance command is triggered, prompting the user to acknowledge and enforce compliance.

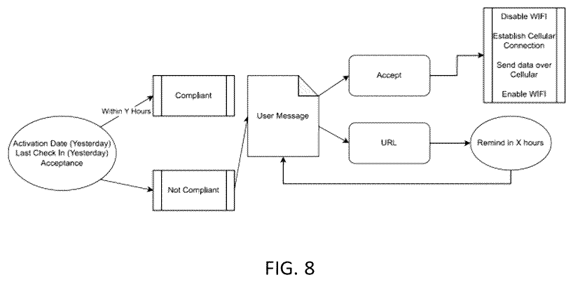

Referring to FIG. 7, the logic controller 181 may determine to transmit a compliance command based on an activation date and/or a last check-in. For example, the logic controller 181 could enforce a compliance check (e.g., specific policies or configurations) depending on when the mobile device 100 was initially activated or when it last communicated with the server 125 and the compliance server 180.

As mentioned above, based on an activation date, the compliance server 180 may transmit a compliance command to the EMM server 128 if the user is not compliant. Upon receiving a compliance check command from the EMM server 128, the enterprise command instructions 116 may cause the enterprise command controller application 126 to control the mobile device 100. The device policy controller 127 of the enterprise command controller application 126 may control the mobile device 100 to display a non-compliant message on the device 100. The message may prompt the user to acknowledge their compliance status within the program. Upon accepting/acknowledging the compliance message, the device policy controller 127 may disable the wi-fi antenna 130 and enable the cellular connection via the cellular antenna 135. The device policy controller 127 may then control the mobile device 100 to transmit data via the cellular connection to the cellular network 125. Upon transmitting data via the cellular connection, the device policy controller 127 may control the mobile device 100 to establish the wi-fi connection. The message may also provide a URL. The URL may redirect the user to a website offering comprehensive details regarding the program requirements and compliance protocols. Furthermore, the URL may send a reminder within a certain time for the user to acknowledge and accept the compliance check. The data pertaining to the compliance check may then be provided to the logic controller 181 of the compliance server computer 180 to determine compliance.

Referring to FIG. 8, based on an acceptance date, the logic controller 181 may determine to transmit a compliance command to the EMM server 128 if the user is not compliant. The acceptance date is the date the user accepted or was initiated into the program. Upon receiving a compliance check command 164 from the EMM server computer 128, the enterprise command instructions 116 may cause the device policy controller 127 of the enterprise command controller application 126 to control the mobile device 100. The device policy controller 127 may control the mobile device 100 to display a non-compliant message on the device 100. The message may prompt the user to acknowledge their compliance status within the program. Upon accepting/acknowledging the compliance message, the device policy controller 127 may disable the wi-fi antenna 130 and enable the cellular connection via the cellular antenna 135. The device policy controller 127 may then control the mobile device 100 to transmit data via the cellular connection to the cellular network 125. Upon transmitting data via the cellular connection, the device policy controller 127 may control the mobile device 100 to establish the wi-fi connection. The message may also provide a URL. The URL may redirect the user to a website offering comprehensive details regarding the program requirements and compliance protocols. Furthermore, the URL may send a reminder within a certain time for the user to acknowledge and accept the compliance check. The data pertaining to the compliance check may then be provided to the logic controller 181 of the compliance server computer 180 to determine compliance.

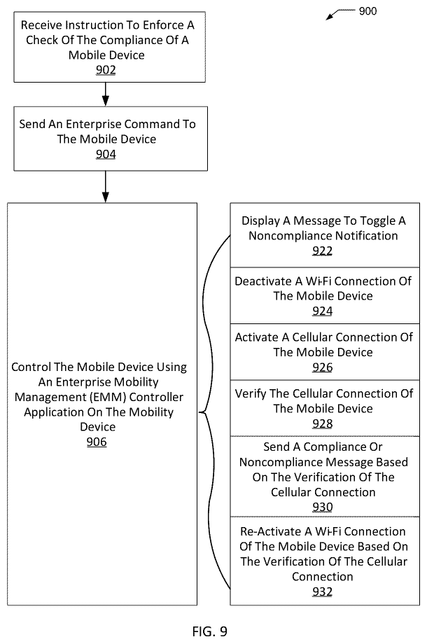

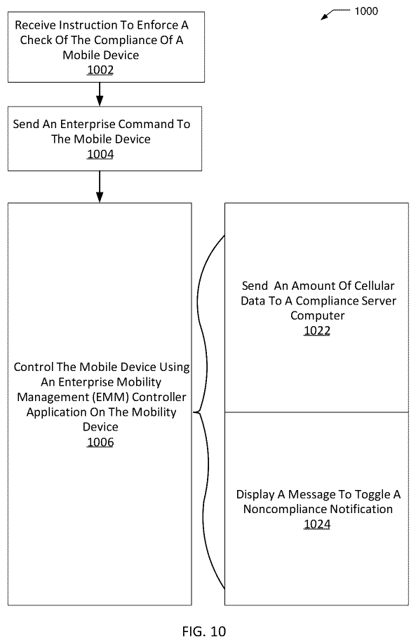

FIGS. 9 and 10 depict flow diagrams of methods for enforcing a compliance of a mobile device with a respect to a cellular connection. Referring to FIG. 9, the method 900 is implemented by one or more of the above-described processors. For instance, the method 900 may be implemented by the processor 158 of the EMM server computer 128 described above in connection with FIG. 1. The characteristics of the processor and the server computer may vary from the examples described above.

The acts of the method 900 may be implemented in accordance with supervisor instructions 116 (FIG. 1) and/or other instructions.

The method 900 enforces compliance of a mobile device with a respect to a cellular connection. The method 900 includes receiving, by a processor 158 of an enterprise mobility management (EMM) server computer 128, instructions to enforce a check of the compliance of the mobile device at act 902. The instructions are from the compliance server computer 180. The method also includes, at act 904, in response to the received instructions, sending, by the processor 158, an enterprise command 164 to the mobile device 100. The enterprise command 164 includes instructions of an EMM controller application 126 on the mobile device. The EMM controller application 126 is configured to control the mobile device 100 to enforce the check, at act 906.

In connection with acts 922-932, a device policy controller 127 of the EMM command controller application 126 is configured to cause the mobile device 100 to enforce compliance through a series of tasks. Upon receiving a compliance check command 164 from the EMM server computer 128, the enterprise command instructions 116 may cause the enterprise command controller application 126 to control the mobile device 100. The device policy controller 127 of the enterprise command controller application 126 may control the mobile device 100 to display a non-compliant message on the device 100. The message may prompt the user to acknowledge their compliance status within the program. Upon accepting/acknowledging the compliance message, the device policy controller 127 may disable the wi-fi antenna 130 and enable the cellular connection via the cellular antenna 135. The device policy controller 127 may then control the mobile device 100 to transmit data via the cellular connection to the cellular network 125. Upon transmitting data via the cellular connection, the device policy controller 127 may control the mobile device 100 to establish the wi-fi connection. The message may also provide a URL. The URL may redirect the user to a website offering comprehensive details regarding the program requirements and compliance protocols. Furthermore, the URL may send a reminder within a certain time for the user to acknowledge and accept the compliance check. The data pertaining to the compliance check may then be provided to the logic controller 181 of the compliance server computer 180 to determine compliance.

Referring to FIG. 10, the method 1000 is implemented by one or more of the above-described processors. The method 1000 includes receiving, by a processor 158 of an enterprise mobility management (EMM) server computer 128, instructions to enforce a check of the compliance of the mobile device at act 1002. The instructions are received from the compliance server computer 180. The method also includes, at act 1004, in response to the received instructions, sending, by the processor 158, an enterprise command 164 to the mobile device 100. The enterprise command 164 includes instructions of an EMM controller application 126 on the mobile device 100. The EMM controller application is configured to control the mobile device 100 to enforce the check, at act 1006.

In connection with acts 1022 and 1024, a device policy controller 127 of the EMM command controller application 126 is configured to cause the mobile device 100 to enforce compliance through a series of tasks. The device policy controller 127 may control the mobile device 100 to display a non-compliant message on the device 100. The message may prompt the user to acknowledge their compliance status within the program. Upon accepting/acknowledging the compliance message, the device policy controller 127 may disable the wi-fi antenna 130 and enable the cellular connection via the cellular antenna 135. The device policy controller 127 may then control the mobile device 100 to transmit data via the cellular connection to the cellular network 125. Upon transmitting data via the cellular connection, the device policy controller may control the mobile device 100 to re-establish the wi-fi connection.

The term “about” is used herein in a manner to include deviations from a specified value that would be understood by one of ordinary skill in the art to effectively be the same as the specified value due to, for instance, the absence of appreciable, detectable, or otherwise effective difference in operation, outcome, characteristic, or other aspect of the disclosed methods and devices.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. A method of enforcing a cellular connection policy for a mobile device, the method comprising:
receiving, by a processor of an enterprise mobility management (EMM) server computer, an instruction to enforce compliance with the cellular connection policy, the instruction being sent from a compliance server computer; and
in response to the received instruction, sending, by the processor, an EMM command to a device policy controller on the mobile device;
wherein the EMM command configures the device policy controller to control the mobile device to enforce compliance with the cellular connection policy.

2. The method of claim 1, wherein the device policy controller is further configured by the EMM command to cause the mobile device to display, by a user interface of the mobile device, a message to toggle a noncompliance notification upon receipt of the EMM command from the EMM server computer.

3. The method of claim 1, wherein the device policy controller is further configured by the EMM command to cause the mobile device to deactivate a Wi-Fi connection of the mobile device upon receipt of the EMM command from the EMM server computer.

4. The method of claim 1, wherein the device policy controller is further configured by the EMM command to cause the mobile device to activate a cellular connection of the mobile device upon receipt of the EMM command from the EMM server computer.

5. The method of claim 1, wherein the device policy controller is further configured by the EMM command to cause the mobile device to verify a cellular connection of the mobile device upon receipt of the EMM command from the EMM server computer.

6. The method of claim 1, wherein the device policy controller is further configured by the EMM command to cause the mobile device to send cellular data through a cellular antenna of the mobile device to a cellular network.

7. The method of claim 1, wherein the device policy controller is further configured by the EMM command to cause the mobile device to send a compliance message to the compliance server computer based on whether the compliance with the cellular connection policy has been achieved.

8. The method of claim 1, wherein the device policy controller is further configured by the EMM command to cause the mobile device to re-activate a Wi-Fi connection of the mobile device based on whether the compliance with the cellular connection policy has been achieved.

9. The method of claim 1, wherein the device policy controller is configured to send data indicative of an amount of cellular data used by the mobile device to the compliance server computer.

10. The method of claim 1, wherein the instruction is sent from the compliance server computer based on whether a cellular data threshold has been satisfied by the mobile device, based on an activation date of the mobile device, based on a non-activation date of the mobile device, or based on a check-in date.

11. A system for enforcing a cellular connection policy for a mobile device, the system comprising:
a memory on which an enterprise mobility management (EMM) command is stored; and
a processor configured to send the EMM command to a device policy controller on the mobile device in response to an instruction from a compliance server computer to enforce compliance with the cellular connection policy;
wherein the EMM command configures the device policy controller to control the mobile device to enforce compliance with the cellular connection policy.

12. The system of claim 11, wherein the device policy controller is further configured by the EMM command to cause the mobile device to display, by a user interface of the mobile device, a message to toggle a noncompliance notification upon receipt of the EMM command from the EMM server computer.

13. The system of claim 11, wherein the device policy controller is further configured by the EMM command to cause the mobile device to deactivate a Wi-Fi connection of the mobile device upon receipt of the EMM command from the EMM server computer.

14. The system of claim 11, wherein the device policy controller is further configured by the EMM command to cause the mobile device to activate a cellular connection of the mobile device upon receipt of the EMM command from the EMM server computer.

15. The system of claim 11, wherein the device policy controller is further configured by the EMM command to cause the mobile device to verify a cellular connection of the mobile device upon receipt of the EMM command from the EMM server computer.

16. The system of claim 11, wherein the device policy controller is further configured by the EMM command to cause the mobile device to send cellular data through a cellular antenna of the mobile device to a cellular network.

17. The system of claim 11, wherein the device policy controller is further configured by the EMM command to cause the mobile device to send a compliance message to the compliance server computer based on whether the compliance with the cellular connection policy has been achieved.

18. The system of claim 11, wherein the device policy controller is further configured by the EMM command to cause the mobile device to re-activate a Wi-Fi connection of the mobile device based on whether the compliance with the cellular connection policy has been achieved.

19. The system of claim 11, wherein the device policy controller is configured to send data indicative of an amount of cellular data used by the mobile device to the compliance server computer.

20. The system of claim 11, wherein the instruction is sent from the compliance server computer based on whether a cellular data threshold has been satisfied by the mobile device, based on an activation date of the mobile device, based on a non-activation date of the mobile device, or based on a check-in date.
